(19) United States
(12) Patent Application Publication
(10) Pub. No.: US 2006/0233253 A1
(43) Pub. Date: Oct. 19, 2006

(54) Interpolated frame deblocking operation for frame rate up conversion applications

(75) Inventors: Fang Shi, San Diego, CA (US); Vijayalakshmi Rajasundaram Raveendran, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 11/372,939

(22) Filed: Mar. 9, 2006

Related U.S. Application Data
(60) Provisional application No. 60/660,909, filed on Mar. 10, 2005.

(51) Int. Cl. H04N 11/02; H04N 11/04; H04N 7/12; H04B 1/66

(52) U.S. Cl. 375/240.16; 375/240.24

(57) ABSTRACT

A method and apparatus to enhance the quality of interpolated video, constructed from decompressed video data, comprising denoising the interpolated video data, is described. A low pass filter is used to filter the interpolated video data. In one embodiment, the level of filtering of the low pass filter is determined based on a boundary strength value determined for the interpolated video data and neighboring video data (interpolated and/or non-interpolated). In one aspect of this embodiment, the boundary strength is determined based on proximity of reference video data for the interpolated video data and the neighboring video data.

### CLAIM OF PRIORITY UNDER 35 U.S.C. §119

The present Application for Patent claims priority to Provisional Application No. 60/660,909, filed Mar. 10, 2005, and assigned to the assignee hereof and hereby expressly incorporated by reference herein.

### BACKGROUND OF THE INVENTION

1. Field of the Invention

The invention relates to data compression in general and to denoising the process video in particular.

2. Description of the Related Art

Block-based compression may introduce artifacts between block boundaries, particularly if the correlation between block boundaries are not taken into consideration.

Scalable video coding is acquiring widespread acceptance into low bit rate applications, particularly in heterogeneous networks with varying bandwidths (e.g. Internet and wireless streaming). Scalable video coding enables coded video to be transmitted as multiple layers—typically, a base layer contains the most valuable information and occupies the least bandwidth (lowest bit rate for the video) and enhancement layers offer refinements over the base layer. Most scalable video compression technologies exploit the fact that the human visual system is more forgiving of noise (due to compression) in high frequency regions of the image than the flatter, low frequency regions. Hence, the base layer predominantly contains low frequency information and high frequency information is carried in enhancement layers. When network bandwidth falls short, there is a higher probability of receiving just the base layer of the coded video (no enhancement layers).

If enhancement layer or base layer video information is lost due to channel conditions or dropped to conserve battery power, any of several types of interpolation techniques may be employed to replace the missing data. For example, if an enhancement layer frame is lost, then data representing another frame, such as a base layer frame, could be used to interpolate data for replacing the missing enhancement layer data. Interpolation may comprise interpolating motion compensated prediction data. The replacement video data may typically suffer from artifacts due to imperfect interpolation.

As a result, there is a need for post-processing algorithms for denoising interpolated data so as to reduce and/or eliminate interpolation artifacts.

### SUMMARY OF THE INVENTION

A method of processing video data is provided. The method includes interpolating video data and denoising the interpolated video data. In one aspect, the interpolated video data comprises first and second blocks, and the method includes determining a boundary strength value associated with the first and second blocks and denoising the first and second blocks by using the determined boundary strength value.

A processor for processing video data is provided. The processor is configured to interpolate video data, and denoise the interpolated video data. In one aspect, the interpolated video data includes first and second blocks, and the processor is configured to determine a boundary strength value associated with the first and second blocks, and denoise the first and second blocks by using the determined boundary strength value.

An apparatus for processing video data is provided. The apparatus includes an interpolator to interpolate video data, and a denoiser to denoise the interpolated video data. In one aspect, the interpolated video data comprises first and second blocks, and the apparatus includes a determiner to determine boundary strength value associated with the first and second blocks, and the denoiser denoises the first and second blocks by using the determined boundary strength value.

An apparatus for processing video data is provided. The apparatus includes means for interpolating video data, and means for denoising the interpolated video data. In one aspect, the interpolated video data includes first and second blocks, and the apparatus includes means for determining boundary strength value associated with the first and second blocks, and means for denoising the first and second blocks by using the determined boundary strength value.

A computer readable medium embodying a method of processing video data is provided. The method includes interpolating video data, and denoising the interpolated video data. In one aspect, the interpolated video data comprises first and second blocks, and the method includes determining boundary strength value associated with the first and second blocks, and denoising the first and second blocks by using the determined boundary strength value.

### BRIEF DESCRIPTION OF THE DRAWINGS

FIG. 1 is an illustration of an example of a video decoder system for decoding and displaying streaming video.

FIG. 2 is a flowchart illustrating an example of a process for performing denoising of interpolated video data to be displayed on a display device.

FIG. 3A shows an example of motion vector interpolation used in some embodiments of the process of FIG. 1.

FIG. 3B shows an example of spatial interpolation used in some embodiments of the process of FIG. 1.

FIG. 4 is an illustration of pixels adjacent to vertical and horizontal 4×4 block boundaries.

FIGS. 5A, 5B and 5C illustrate reference block locations used in determining boundary strength values in some embodiments of the process of FIG. 1.

FIGS. 6A and 6B are flowcharts illustrating examples of processes for determining boundary strength values.

FIG. 7 illustrates an example method for processing video data.

FIG. 8 illustrates an example apparatus for processing video data.

### DETAILED DESCRIPTION OF THE PREFERRED EMBODIMENT

A method and apparatus to enhance the quality of interpolated video, constructed from decompressed video data, comprising denoising the interpolated video data, are described. A low pass filter is used to filter the interpolated video data. In one example, the level of filtering of the low pass filter is determined based on a boundary strength value determined for the interpolated video data and neighboring video data (interpolated and/or non-interpolated). In one aspect of this example, the boundary strength is determined based on proximity of reference video data for the interpolated video data and the neighboring video data. In the following description, specific details are given to provide a thorough understanding of the embodiments. However, it can be understood by one of ordinary skill in the art that the embodiments may be practiced without these specific details. For example, electrical components may be shown in block diagrams in order not to obscure the embodiments in unnecessary detail. In other instances, such components, other structures and techniques may be shown in detail to further explain the embodiments. It is also understood by skilled artisans that electrical components, which are shown as separate blocks, can be rearranged and/or combined into one component.

It is also noted that some embodiments may be described as a process, which is depicted as a flowchart, a flow diagram, a structure diagram, or a block diagram. Although a flowchart may describe the operations as a sequential process, many of the operations can be performed in parallel or concurrently and the process can be repeated. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

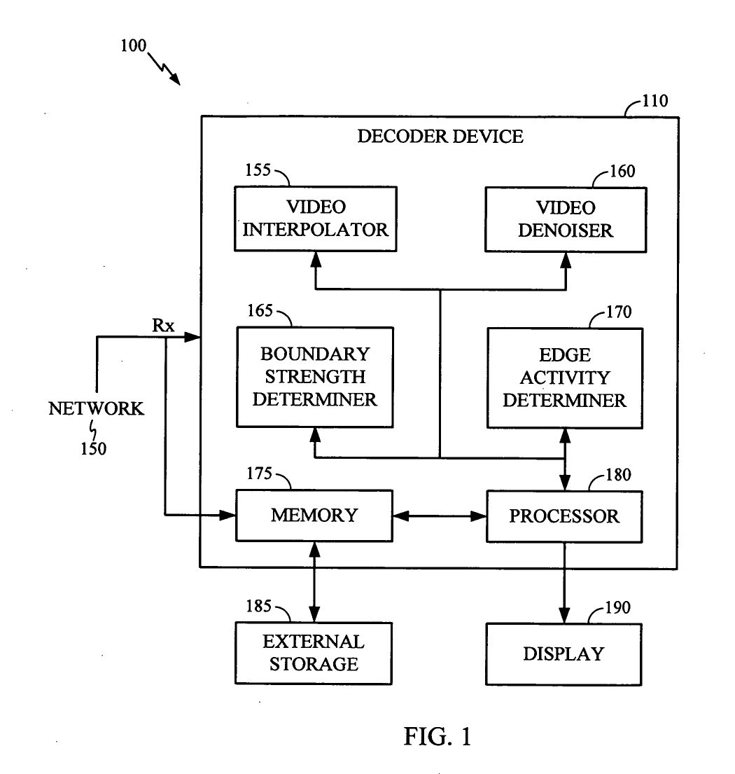

FIG. 1 is a block diagram of a video decoder system for decoding streaming data. The system 100 includes decoder device 110, network 150, external storage 185 and a display 190. Decoder device 110 includes a video interpolator 155, a video denoiser 160, a boundary strength determiner 165, an edge activity determiner 170, a memory component 175, and a processor 180. Processor 180 generally controls the overall operation of the example decoder device 110. One or more elements may be added, rearranged or combined in decoder device 110. For example, processor 180 may be external to decoder device 110.

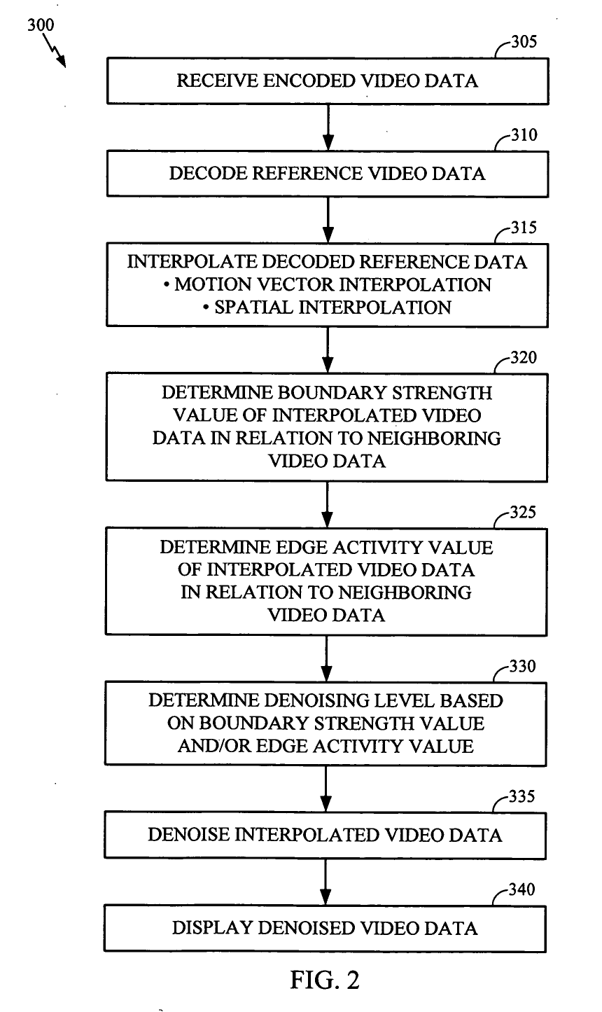

FIG. 2 is a flowchart illustrating an example of a process for performing denoising of interpolated video data to be displayed on a display device. With reference to FIGS. 1 and 2, process 300 begins at step 305 with the receiving of encoded video data. The processor 180 can receive the encoded video data (such as MPEG-4 or H.264 compressed video data) from the network 150 or an image source such as the internal memory component 175 or the external storage 185. The encoded video data may be MPEG-4 or H.264 compressed video data. Here, the memory component 175 and/or the external storage 185 may be a digital video disc (DVD) or a hard-disc drive that contains the encoded video data.

Network 150 can be part of a wired system such as telephone, cable, and fiber optic, or a wireless system. In the case of wireless, communication systems, network 150 can comprise, for example, part of a code division multiple access (CDMA or CDMA2000) communication system or alternately, the system can be a frequency division multiple access (FDMA) system, an orthogonal frequency division multiple access (OFDMA) system, a time division multiple access (TDMA) system such as GSM/GPRS (General Packet Radio Service)/EDGE (enhanced data GSM environment) or TETRA (Terrestrial Trunked Radio) mobile telephone technology for the service industry, a wideband code division multiple access (WCDMA), a high data rate (1xEV-DO or 1xEV-DO Gold Multicast) system, or in general any wireless communication system employing a combination of techniques.

Process 300 continues at step 310 with decoding of the received video data, wherein at least some of the received video data may be decoded and used as reference data for constructing interpolated video data as will be discussed below. In one example, the decoded video data comprises texture information such as luminance and chrominance values of pixels. The received video data may be intra-coded data where the actual video data is transformed (using, e.g., a discrete cosine transform, a Hadamard transform, a discrete wavelet transform or an integer transform such as used in H.264), or it can be inter-coded data (e.g., using motion compensated prediction) where a motion vector and residual error are transformed. Details of the decoding acts of step 310 are known to those of skill in the art and will not be discussed further herein.

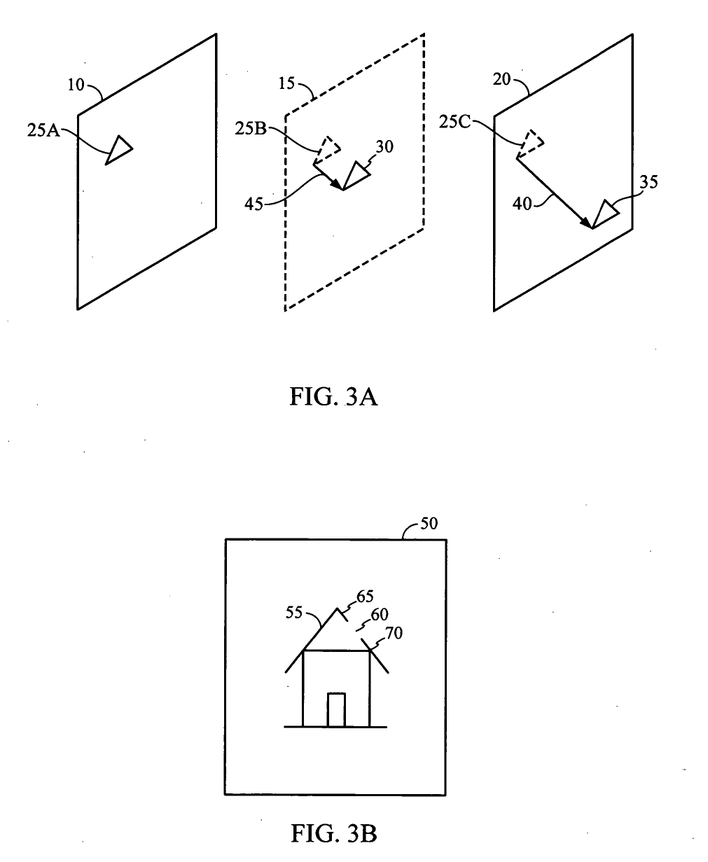

Process 300 continues at step 315 where the decoded reference data is interpolated. In one example, interpolation at step 315 comprises interpolation of motion vector data from reference video data. In order to illustrate interpolation of motion vector data, a simplified example will be used. FIG. 3A shows an example of motion vector interpolation used in step 315. Frame 10 represents a frame at a first temporal point in a sequence of streaming video. Frame 20 represents a frame at a second temporal point in the sequence of streaming video. Motion compensated prediction routines, known to those of skill in the art, may be used to locate a portion of video containing an object 25A in frame 10 that closely matches a portion of video containing an object 35 in frame 20. A motion vector 40 locates the object 25A in frame 10 relative to the object 35 in frame 20 (a dashed outline labeled 25C in frame 20 is used to illustrate the relative location of objects 25A and 35). If frame 10 and frame 20 are located a time “T” from each other in the sequence, then a frame 15, located in between frames 10 and 20, can be interpolated based on the decoded video data in frame 10 and/or frame 20. For example, if frame 15 is located at a point in time midway between (a time T/2 from both) frames 10 and 20, then the pixel data of object 35 (or object 25A) could be located at a point located by motion vector 45 which may be determined through interpolation to be half the size of and in the same heading as motion vector 40 (a dashed outline labeled 25B in frame 15 is used to illustrate and the relative location of objects 25A and 30). Since object 35 was predicted based on object 25A (represented as a motion vector pointing to object 25A and a residual error added to the pixel values of object 25A), object 25A and/or object 35 could be used as reference portions for interpolating object 30 in frame 15. As would be clear to those of skill in the art, other methods of interpolating motion vector and/or residual error data of one or more reference portions (e.g., using two motion vectors per block as in bidirectional prediction) can be used in creating the interpolated data at step 315.

In another example, interpolation at step 315 comprises combining of pixel values located in a different spatial region of the video frame. FIG. 3b shows an example of spatial interpolation used in step 315 of the process 300. A frame 50 contains a video image of a house 55. A region of the video data, labeled 60, is missing, e.g., due to data corruption. Spatial interpolation of features 65 and 70 that are located near the missing portion 60 may be used as reference portions to interpolate region 60. Interpolation could be simple linear interpolation between the pixel values of regions 65 and 70. In another example, pixel values located in different temporal frames from the frame containing the missing data, can be combined (e.g., by averaging) to form the interpolated pixel data. Interpolating means such as the video interpolator 155 of FIG. 1 may perform the interpolation acts of step 315.

Besides motion vectors, other temperal prediction methods such as optical flow data and image morphing data may also be utilized for interpolating video data. Optical flow interpolation may transmit the velocity field of pixels in an image over the time. The interpolation may be pixel-based derived from the optical flow field, for a given pixel. The interpolation data may comprise speed and directional information.

Image morphing is an image processing technique used to compute a transformation, from one image to another. Image morphing creates a sequence of intermediate images, which when put together with the original images, represents the transition from one image to the other. The method identifies the mesh points of the source image, and warping functions of the points for a non-linear interpolation, see Wolberg, G., “Digital Image Warping”. IEEE Computer Society Press, 1990.

Steps 320, 325 and 330 are optional steps used with some embodiments of denoising performed at step 335 and will be discussed in detail below. Continuing to step 335, the interpolated video data is denoised so as to remove artifacts that may have resulted from the interpolation acts of step 315. Denoising means such as the video denoiser 160 of FIG. 1 may perform the acts of step 335. Denoising may comprise one or more methods known to those of skill in the art including deblocking to reduce blocking artifacts, deringing to reduce ringing artifacts and methods to reduce motion smear. After denoising, the denoised video data is displayed, e.g., on the display 190 as shown in FIG. 1.

An example of denoising at step 335 comprises using a deblocking filter, for example, the deblocking filter of the H.264 video compression standard. The deblocking filter specified in H.264 requires decision trees that determine the activity along block boundaries. As originally designed in H.264, block edges with image activity beyond set thresholds are not filtered or weakly filtered, while those along low activity blocks are strongly filtered. The filters applied can be, for example, 3-tap or 5-tap low pass Finite Impulse Response (FIR) filters.

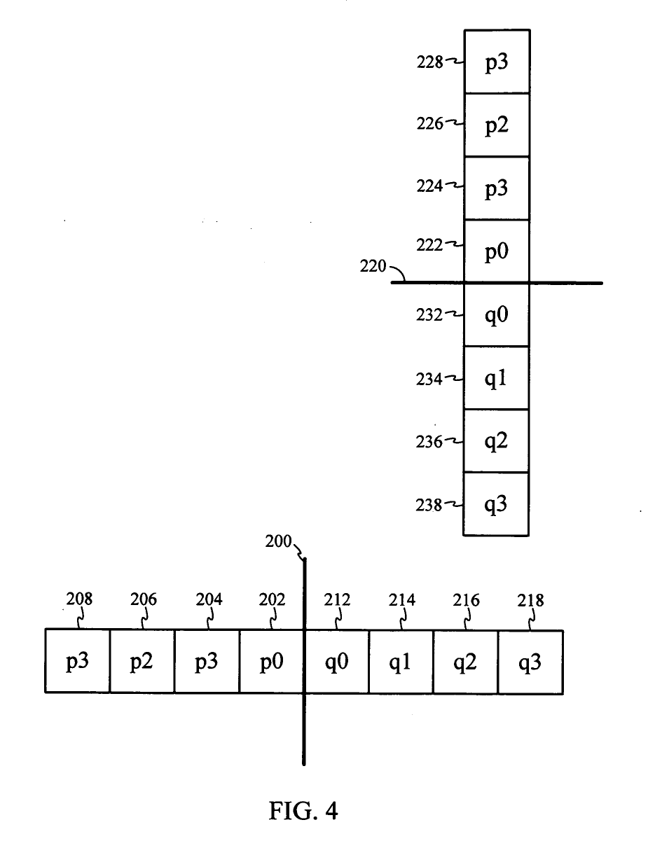

FIG. 4 is an illustration of pixels adjacent to vertical and horizontal 4×4 block boundaries (a current block “q” and a neighboring block “p”). Vertical boundary 200 represents any boundary between two side-by-side 4×4 blocks. Pixels 202, 204, 206 and 208, labeled p0, p1, p2 and p3 respectively, lie to the left of vertical boundary 200 (in block “p”) while pixels 212, 214, 216 and 218, labeled q0, q1, q2 and q3 respectively, lie to the right of vertical boundary 200 (in block “q”). Horizontal boundary 220 represents any boundary between two 4×4 blocks, one directly above the other. Pixels 222, 224, 226 and 228, labeled p0, p1, p2 and p3 respectively, lie above horizontal boundary 200 while pixels 232, 234, 236 and 238, labeled q0, q1, q2 and q3 respectively, lie below horizontal boundary 200. In an embodiment of deblocking in H.264, the filtering operations affect up to three pixels on either side of, above or below the boundary. Depending on the quantizer used for transformed coefficients, the coding modes of the blocks (intra or inter coded), and the gradient of image samples across the boundary, several outcomes are possible, ranging from no pixels filtered to filtering pixels p0, p1, p2, q0, q1 and q2.

Deblocking filter designs for block based video compression predominantly follow a common principle, the measuring of intensity changes along block edges, followed by a determination of strength of the filter to be applied and then by the actual low pass filtering operation across the block edges. The deblocking filters reduces blocking artifacts through smoothing (low pass filtering across) of block edges. A measurement, known as boundary strength, is determined at step 320. Boundary strength values may be determined based on content of the video data, or on the context of the video data. In one aspect, higher boundary strengths result in higher levels of filtering (e.g., more blurring). Parameters affecting the boundary strength include context and/or content dependent situations, such as whether the data is intra-coded or inter-coded, where intra-coded regions are generally filtered more heavily than inter-coded portions. Other parameters affecting the boundary strength measurement are the coded block pattern (CPB) which is a function of the number of non-zero coefficients in a 4 by 4 pixel block and the quantization parameter.

In order to avoid blurring of edge features in the image, an optional edge activity measurement may be performed at step 325 and low pass filtering (at the denoising step 335) is normally applied in non-edge regions (the lower the edge activity measurement in the region, the stronger the filter used in the denoising at step 335). Details of boundary strength determination and edge activity determination are known to those of ordinary skill in the art and are not necessary to understand the disclosed method. At step 330, the boundary strength measurement and/or the edge activity measurement are used to determine the level of denoising to be performed at step 335. Through modifications to the deblocking parameters such as boundary strength and/or edge activity measurements, interpolated regions can be effectively denoised. Process 300 may conclude by displaying 340 the denoised interpolated video data. One or more elements may be added, rearranged or combined in process 300.

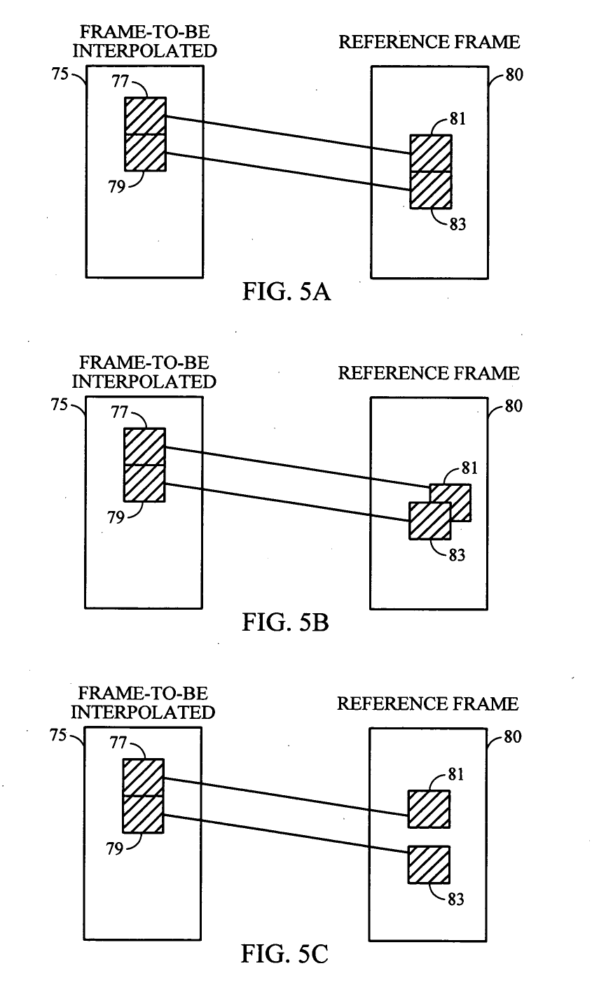

FIGS. 5A, 5B and 5C show illustrations of reference block locations used in determining boundary strength values at step 320 in some embodiments of the process of FIG. 1 where the denoising act of step 335 comprises deblocking. The scenarios depicted in FIG. 5 are representative of motion compensated prediction with one motion vector per reference block, as discussed above in relation to FIG. 3A. In FIGS. 5A, 5B and 5C, a frame being interpolated 75, is interpolated based on a reference frame 80. An interpolated block 77 is interpolated based on a reference block 81, and an interpolated Block 79, that is a neighboring block of block 77, is interpolated based on a reference block 83. In FIG. 5A, the reference blocks 81 and 83 are also neighboring. This is indicative of video images that are stationary between the interpolated frame 75 and the reference frame 80. In this case, the boundary strength may be set low so that the level of denoising is low. In FIG. 5B, the reference blocks 81 and 83 are overlapped so as to comprise common video data. Overlapped blocks may be indicative of some slight motion and the boundary strength may be set higher than for the case in FIG. 5A. In FIG. 5C, the reference blocks 81 and 83 are apart from each other (non-neighboring blocks). This is an indication that the images are not closely associated with each other and blocking artifacts could be more severe. In the case of FIG. 5C, the boundary strength would be set to a value resulting in more deblocking than the scenarios of FIGS. 5A or 5B. A scenario not shown in any of FIGS. 5 comprises reference blocks 81 and 83 from different reference frames. This case may be treated in a similar manner to the case shown in FIG. 5C or the boundary strength value may be determined to be a value that results in more deblocking than the case shown in FIG. 5C.

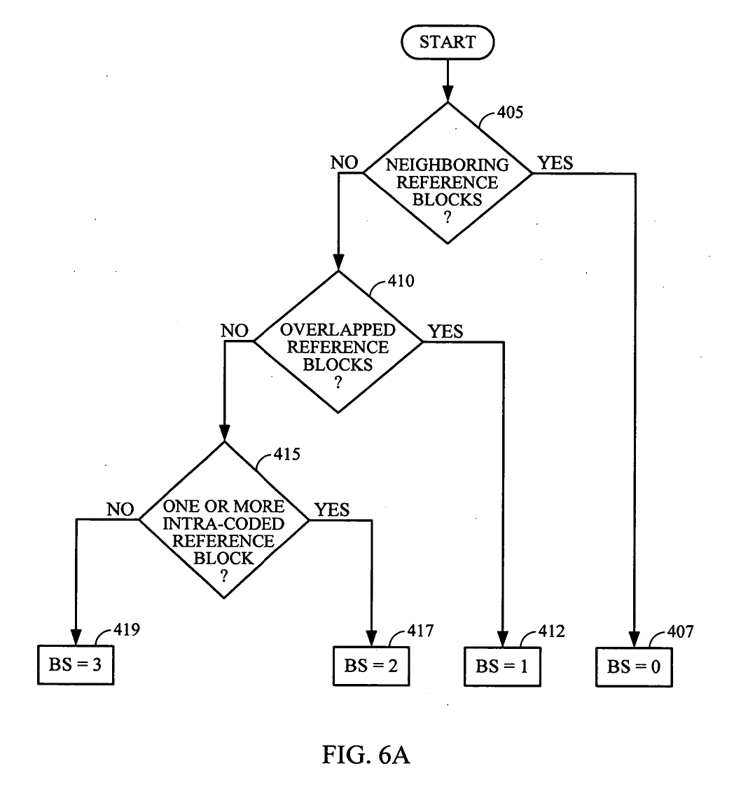

FIG. 6A is a flowchart illustrating an example of a process for determining boundary strength values for the situations shown in FIGS. 5A, 5B and 5C with one motion vector per block. The process shown in FIG. 6A may be performed in step 320 of the process 300 shown in FIG. 2. With reference to FIGS. 5 and 6, a check is made at decision block 405, to determine if the reference blocks 81 and 83 are also neighboring blocks. If they are neighboring blocks as shown in FIG. 5A, then the boundary strength is set to zero at step 407. In those embodiments, where the neighboring reference blocks 81 and 83 are already denoised (deblocked in this example), the denoising of the interpolated blocks 77 and 79 at step 335 may be omitted. If the reference blocks 81 and 83 are not neighboring reference blocks, then a check is made at decision block 410 to determine of the reference blocks 81 and 83 are overlapped. If the reference blocks 81 and 83 are overlapped, as shown in FIG. 5B, then the boundary strength is set to 1 at step 412. If the reference blocks are not overlapped (e.g., the reference blocks 81 and 83 are apart in the same frame or in different frames), then the process continues at decision block 415. A check is made at decision block 415 to determine if one or both of the reference blocks 81 and 83 are intra-coded. If one of the reference blocks is intra-coded, then the boundary strength is set to two at step 417, otherwise the boundary strength is set to three at step 419 In this example, neighboring blocks that are interpolated from reference blocks that are located proximal to each other, are denoised at lower levels than blocks interpolated from separated reference blocks.

Interpolated blocks may also be formed from more than one reference block. FIG. 6B is a flowchart illustrating another embodiment of a process for determining boundary strength values (as performed in step 320 of FIG. 2) for interpolated blocks comprising two motion vectors pointing to two reference blocks. The example shown in FIG. 6B assumes that the motion vectors point to a forward frame and a backward frame as in bi-directional predicted frames. Those of skill in the art would recognize that multiple reference frames may comprise multiple forward or multiple backward reference frames as well. The example looks at the forward and backward motion vectors of a current block being interpolated and a neighboring block in the same frame. If the forward located reference blocks, as indicated by the forward motion vectors of the current block and the neighboring block, are determined to be neighboring blocks at decision block 420, then the process continues at decision block 425 to determine if the backward reference blocks, as indicated by the backward motion vectors of the current block and the neighboring block, are also neighboring. If both the forward and backward reference blocks are neighboring then this is indicative of very little image motion and the boundary strength is set to zero at step 427 which results in a low level of deblocking. If one of the forward or backward reference blocks is determined to be neighboring (at decision block 425 or decision block 430) then the boundary strength is set to 1 (at step 429 or step 432) resulting in more deblocking than the case where both reference blocks are neighboring. If, at decision block 430, it is determined that neither the forward nor the backward reference blocks are neighboring, then the boundary strength is set to two, resulting in even more deblocking.

The decision trees shown in FIGS. 6A and 6B are only examples of processes for determining boundary strength based on the relative location of one or more reference portions of interpolated video data, and on the number of motion vectors per block. Other methods may be used as would be apparent to those of skill in the art. Determiner means such as boundary strength determiner 165 in FIG. 1 may perform the acts of step 320 shown in FIG. 2 and illustrated in FIGS. 6A and 6B. One or more elements may be added, rearranged or combined in the decisions trees shown in FIGS. 6A and 6B.

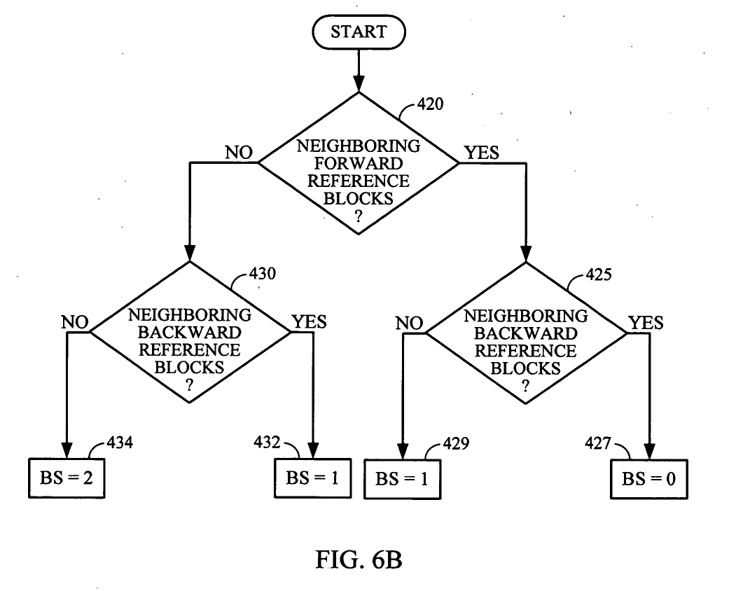

FIG. 7 illustrates one example method 700 of processing video data in accordance to the description above. Generally, method 700 comprises interpolating 710 video data and denoising 720 the interpolated video data. The denoising of the interpolated video data may be based on a boundary strength value as described above. The boundary strength may be determined based on content and/or context of the video data. Also, the boundary strength may be determined based on whether the video data was interpolated using one motion vector or more than one motion vector. If one motion vector was used, the boundary strength may be determined based on whether the motion vectors are from neighboring blocks of a reference frame, from overlapped neighboring blocks of a reference frame, from non-neighboring blocks of a reference frame, or from different reference frames. If more than one motion vectors were used, the boundary strength may be determined based on whether the forward motion vectors point to neighboring reference blocks or whether the backward motion vectors point to neighboring reference blocks.

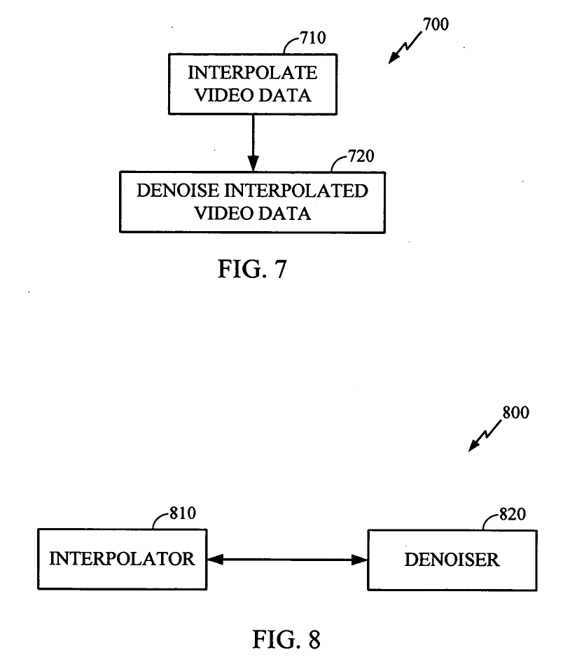

FIG. 8 shows an example apparatus 800 that may be implemented to carry out a method 700. Apparatus 800 comprises an interpolator 810 and a denoiser 820. The interpolator 810 may interpolate video data and the denoiser 820 may denoise the interpolated video data, as described above.

The embodiment of deblocking discussed above is only an example of one type of denoising. Other types of denoising would be apparent to those of skill in the art. The deblocking algorithm of H.264 described above utilizes 4 by 4 pixel blocks. It would be understood by those of skill in the art that blocks of various sizes, e.g., any N by M block of pixels where N and M are integers, could be used as interpolated and/or reference portions of video data.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill would further appreciate that the various illustrative logical blocks, modules, and algorithm steps described in connection with the examples disclosed herein may be implemented as electronic hardware, firmware, computer software, middleware, microcode, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed methods.

The various illustrative logical blocks, components, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem.

The previous description of the disclosed examples is provided to enable any person of ordinary skill in the art to make or use the disclosed methods and apparatus. Various modifications to these examples would be readily apparent to those skilled in the art, and the principles defined herein may be applied to other examples and additional elements may be added.

Thus, methods and apparatus to decode real-time streaming multimedia, utilizing bit corruption flagging information and corrupt data, in a decoder application, to perform intelligent error concealment and error correction of the corrupt data, have been described.

What is claimed is:

1. A method of processing video data, comprising:
interpolating video data; and
denoising the interpolated video data.

2. The method of claim 1, wherein the interpolated video data comprises first and second blocks, the method further comprising:
determining boundary strength value associated with the first and second blocks; and
denoising the first and second blocks by using the determined boundary strength value.

3. The method of claim 2, wherein determining the boundary strength value comprises:
determining the boundary strength value based on content of the video data.

4. The method of claim 2, wherein determining the boundary strength value comprises:
determining the boundary strength value based on context of the video data.

5. The method of claim 2, wherein the interpolating comprises:
interpolating based on one motion vector; and wherein the determining the boundary strength value comprises:
determining whether the motion vectors of the first and second blocks are from neighboring blocks of a reference frame.

6. The method of claim 2, wherein the interpolating comprises:
interpolating based on one motion vector; and wherein the determining the boundary strength value comprises:
determining whether the motion vectors of the first and second blocks are from overlapped neighboring blocks of a reference frame.

7. The method of claim 2, wherein the interpolating comprises:
interpolating based on one motion vector; and wherein the determining the boundary strength value comprises:
determining whether the motion vectors of the first and second blocks are from non-neighboring blocks of a reference frame.

8. The method of claim 2, wherein the interpolating comprises:
interpolating based on one motion vector; and wherein the determining the boundary strength value comprises:
determining whether the motion vectors of the first and second blocks are from different reference frames.

9. The method of claim 2, wherein the interpolating comprises:
interpolating based on two motion vectors; and wherein the determining the boundary strength value comprises:
determining whether the forward motion vectors of the first and second blocks point to neighboring reference blocks.

10. The method of claim 2, wherein the interpolating comprises:
interpolating based on two motion vectors; and wherein the determining the boundary strength value comprises:
determining whether the backward motion vectors of the first and second blocks point to neighboring reference blocks.

11. A processor for processing video data, the processor configured to:
interpolate video data; and
denoise the interpolated video data.

12. The processor of claim 11, wherein the interpolated video data comprises first and second blocks, the processor further configured to:
determine boundary strength value associated with the first and second blocks; and
denoise the first and second blocks by using the determined boundary strength value.

13. The processor of claim 12 further configured to:
determine the boundary strength value based on content of the video data.

14. The processor of claim 12 further configured to:
determine the boundary strength value based on context of the video data.

15. The processor of claim 12, further configured to:
interpolate based on one motion vector; and
determine boundary strength value based on whether the motion vectors of the first and second blocks are from neighboring blocks of a reference frame.

16. The processor of claim 12 further configured to:
interpolate based on one motion vector; and
determine boundary strength value based on whether the motion vectors of the first and second blocks are from overlapped neighboring blocks of a reference frame.

17. The processor of claim 12 further configured to:
interpolate based on one motion vector; and
determine boundary strength value based on whether the motion vectors of the first and second blocks are from non-neighboring blocks of a reference frame.

18. The processor of claim 12 further configured to:
interpolate based on one motion vector; and
determine boundary strength value based on whether the motion vectors of the first and second blocks are from different reference frames.

19. The processor of claim 12 further configured to:
interpolate based on two motion vectors; and
determine boundary strength value based on whether the forward motion vectors of the first and second blocks point to neighboring reference blocks.

20. The processor of claim 12 further configured to:
interpolate based on two motion vectors; and
determine boundary strength value based on whether the backward motion vectors of the first and second blocks point to neighboring reference blocks.

21. An apparatus for processing video data, comprising:
an interpolator to interpolate video data; and
a denoiser to denoise the interpolated video data.

22. The apparatus of claim 21, wherein the interpolated video data comprises first and second blocks, the apparatus further comprising:
a determiner to determine boundary strength value associated with the first and second blocks; and
wherein the denoiser denoises the first and second blocks by using the determined boundary strength value.

23. The apparatus of claim 22, wherein the determiner determines the boundary strength value based on content of the video data.

24. The apparatus of claim 22, wherein the determiner determines the boundary strength value based on context of the video data.

25. The apparatus of claim 22, wherein the interpolator interpolates based on one motion vector; and wherein the determiner determines the boundary strength value based on whether the motion vectors of the first and second blocks are from neighboring blocks of a reference frame.

26. The apparatus of claim 22, wherein the interpolator interpolates based on one motion vector; and wherein the determining determines the boundary strength value based on whether the motion vectors of the first and second blocks are from overlapped neighboring blocks of a reference frame.

27. The apparatus of claim 22, wherein the interpolator interpolates based on one motion vector; and wherein the determiner determines the boundary strength value based on whether the motion vectors of the first and second blocks are from non-neighboring blocks of a reference frame.

28. The apparatus of claim 22, wherein the interpolator interpolates based on one motion vector; and wherein the determiner determines the boundary strength value based on whether the motion vectors of the first and second blocks are from different reference frames.

29. The apparatus of claim 22, wherein the interpolator interpolates based on two motion vectors; and wherein the determiner determines the boundary strength value based on whether the forward motion vectors of the first and second blocks point to neighboring reference blocks.

30. The apparatus of claim 22, wherein the interpolator interpolates based on two motion vectors; and wherein the determiner determines the boundary strength value based on whether the backward motion vectors of the first and second blocks point to neighboring reference blocks.

31. An apparatus for processing video data, comprising:
means for interpolating video data; and
means for denoising the interpolated video data.

32. The apparatus of claim 31, wherein the interpolated video data comprises first and second blocks, the apparatus further comprising:
means for determining boundary strength value associated with the first and second blocks; and
means for denoising the first and second blocks by using the determined boundary strength value.

33. The apparatus of claim 32, wherein the means for determining the boundary strength value further comprises:
means for determining the boundary strength value based on content of the video data.

34. The apparatus of claim 32, wherein the means for determining the boundary strength value further comprises:
means for determining the boundary strength value based on context of the video data.

35. The apparatus of claim 32, wherein interpolating means further comprises:
means for interpolating based on one motion vector; and wherein the means for determining the boundary strength value further comprises:
means for determining whether the motion vectors of the first and second blocks are from neighboring blocks of a reference frame.

36. The apparatus of claim 32, wherein the interpolating means further comprises:
means for interpolating based on one motion vector; and wherein the means for determining the boundary strength value further comprises:
means for determining whether the motion vectors of the first and second blocks are from overlapped neighboring blocks of a reference frame.

37. The apparatus of claim 32, wherein the interpolating means further comprises:
means for interpolating based on one motion vector; and wherein the means for determining the boundary strength value further comprises:
means for determining whether the motion vectors of the first and second blocks are from non-neighboring blocks of a reference frame.

38. The apparatus of claim 32, wherein the interpolating means further comprises:
means for interpolating based on one motion vector; and wherein the means for determining the boundary strength value further comprises:
means for determining whether the motion vectors of the first and second blocks are from different reference frames.

39. The apparatus of claim 32, wherein the means for interpolating further comprises:
means for interpolating based on two motion vectors; and wherein the means for determining the boundary strength value further comprises:
determining whether the forward motion vectors of the first and second blocks point to neighboring reference blocks.

40. The apparatus of claim 32, wherein the means for interpolating further comprises:
means for interpolating based on two motion vectors; and wherein the means for determining the boundary strength value comprises:
means for determining whether the backward motion vectors of the first and second blocks point to neighboring reference blocks.

41. A computer readable medium embodying a method of processing video data, the method comprising:
interpolating video data; and
denoising the interpolated video data.

42. The computer readable medium of claim 41, wherein the interpolated video data comprises first and second blocks, and further wherein the method further comprises:
determining boundary strength value associated with the first and second blocks; and
denoising the first and second blocks by using the determined boundary strength value.

43. The computer readable medium of claim 42, wherein determining the boundary strength value comprises:
determining the boundary strength value based on content of the video data.

44. The computer readable medium of claim 42, wherein determining the boundary strength value comprises:
determining the boundary strength value based on context of the video data.

45. The computer readable medium of claim 42, wherein the interpolating comprises:
interpolating based on one motion vector; and wherein the determining the boundary strength value comprises:
determining whether the motion vectors of the first and second blocks are from neighboring blocks of a reference frame.

46. The computer readable medium of claim 42, wherein the interpolating comprises:
interpolating based on one motion vector; and wherein the determining the boundary strength value comprises:
determining whether the motion vectors of the first and second blocks are from overlapped neighboring blocks of a reference frame.

47. The computer readable medium of claim 42, wherein the interpolating comprises:
interpolating based on one motion vector; and wherein the determining the boundary strength value comprises:
determining whether the motion vectors of the first and second blocks are from non-neighboring blocks of a reference frame.

48. The computer readable medium of claim 42, wherein the interpolating comprises:
interpolating based on one motion vector; and wherein the determining the boundary strength value comprises:
determining whether the motion vectors of the first and second blocks are from different reference frames.

49. The computer readable medium of claim 42, wherein the interpolating comprises:
interpolating based on two motion vectors; and wherein the determining the boundary strength value comprises:
determining whether the forward motion vectors of the first and second blocks point to neighboring reference blocks.

50. The computer readable medium of claim 42, wherein the interpolating comprises:
interpolating based on two motion vectors; and wherein the determining the boundary strength value comprises:
determining whether the backward motion vectors of the first and second blocks point to neighboring reference blocks.
